(19) United States
(12) Patent Application Publication
(10) Pub. No.: US 2012/0056546 A1
(43) Pub. Date: Mar. 8, 2012

(54) Anti-paparazzi/identity protection system

(76) Inventor: Adam Harvey, Brooklyn, NY (US)

(21) Appl. No.: 12/807,530

(22) Filed: Sep. 7, 2010

(51) Int. Cl. H05B 37/02

(52) U.S. Cl. 315/159

(57) ABSTRACT

A method and apparatus described herein uses sensors to detect illumination indicative of an active auto-focus system in the IR, near IR, and visible light spectrums. This signal is used to trigger a light in the visible spectrum that disrupts a contrast differencing, passive auto-focus system.

### BACKGROUND

1. Field

The following description relates generally to identity protection systems, wearable technology and photography, and more particularly, to a system for detecting, preventing, and obscuring photography and video recordings.

2. Background

In hands of an artist, a camera is an expressive machine. But in the hands of the paparazzi, it can become more like a weapon. With large rewards for compromising photos, and extreme advances in digital imaging technology, the paparazzi industry has become a coordinated attack on privacy.

While the laws enacted since Princess Diana's death have strengthened citizens' rights against invasive photography, the net number of paparazzi photographers is on the rise. The rewards for this type of photography have inspired a rising class of amateur paparazzi as well “pint-size paparazzi,” who are as young as teenagers. The phenomenon of shrinking privacy is not limited to celebrities. With the rise of social networking technologies more and more photographic content is finding its way onto the web where it can become impossible for the subject to control. Here, anyone can use this content to derive personal information about an individual; using computer vision techniques such as face recognition, expression analysis, age recognition, and object detection, leading to further violations of one's privacy.

Among the possible methods to overcome this problem, xenon flash bulbs are an obvious choice for counteracting flash photography by overexposing an image because they are the industry standard light source for professional camera flashes. But they fall short as a stand-alone light source component for wearable identity-protection system in several ways: (1) delays between flashes; (2) dangerously high trigger-voltage levels; (3) does not work well as a continuous light source, (4) cannot be pulse-width modulated for long durations, (5) more fragile as they are enclosed in glass, and (6) are not fully dimmable.

It would be desirable to address some of the issues described herein.

### DRAWINGS

FIG. 1 is a circuit diagram of a control circuit for the privacy system configured in accordance with one aspect of the invention;

FIG. 2 is a circuit diagram of a light circuit for the privacy system configured in accordance with one aspect of the invention;

FIG. 3 is a circuit diagram of an alternate circuit for the privacy system configured in accordance with one aspect of the invention;

FIG. 4 is a circuit diagram of another light circuit for the privacy system configured in accordance with one aspect of the invention;

FIG. 5 is a circuit diagram of a power circuit for powering the privacy system configured in accordance with one aspect of the invention;

FIG. 6 is a flow diagram illustrating the operation of the algorithm of the privacy system configured in accordance one aspect of the invention; and

FIG. 7 includes illustrations of a purse that contains the privacy system described herein.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The various embodiments of the anti-paparazzi/identity-protection system described herein are small, safe, versatile, and powerful. It combines sensors and novel algorithms to detect and classify a plurality of flash events, and respond with the appropriate counter-lighting event, which may be a flash, a short burst or sustained event, in the visible or IR spectrum, generated without a delay in between flashes. Such a system can be used to protect one's identity in public and private against photography and video recordings from digital cameras, film cameras, camera-enabled smart phones, video recorders, and surveillance cameras. In various aspects of the anti-paparazzi/identity-protection system, the protection is integrated into various accessories, such as purses, or even articles of clothing, such as belts, shirts, dresses or jackets.

U.S. Pat. No. 6,937,163, issued on Aug 30, 2005, discloses a prior apparatus and method for preventing one's picture from being taken by a person using flash photography. This device uses a high intensity flash unit that is triggered by a sensor, capable of detecting the increase in light or the speed of increase of light. The flash unit is triggered by the light sensor and generates a counteracting flash that saturates an area where the photographic image is being taken. However, there are several concerns with the aforementioned system, including recycle time, and light source differences.

First, a device that uses high-intensity flash units would typically use xenon bulbs, the industry standard for professional photography. Xenon bulbs create a high intensity, short duration flashes by ionizing xenon gas inside the glass flash tube. When used with a battery, xenon flashes are usually powered by capacitors, which store and then discharge a large electrical current. Because the capacitors operate at a higher voltage than the batteries, they require time to charge. This delay in between flashes, known as the recycle time, is problematic for an identity protection device because it creates a window of vulnerability.

Second, there is a concern that using high voltages in a wearable device could be dangerous. Typically, the voltage required to trigger a xenon flash bulb ranges from 2,000 to 150,000 volts, which is high enough to cause serious or even fatal, shocks.

Third, some cameras, such as camera phones, use LED flashes for low-light photography. Instead of providing a quick pulse of light, LED flashes work by providing a continuous source of light. Once enough light has reached the sensor, or the flash has been activated for a preset duration, it turns off. This lighting method differs from the xenon flash unit because it can last from milliseconds to several seconds and it can turn off and on during the recording process. Without knowing how long the delay is between the light turning on and the sensor recording the scene, firing a flash at the beginning of the light event would not be an effective means of overexposing the sensor and might not even affect the auto exposure algorithm. Therefore, an identity protection system needs to be able to provide a continuous light source that can overcome and overwhelm modern lighting methods.

Additionally, many digital cameras are now equipped with video recording capabilities, and vice-versa, making video a more prevalent form of image capture. A device that uses flashes of light to overexpose an area of an image would be ineffective against continuous recording. Therefore, an identity protection system needs to provide a defense mechanism against video as well.

In one aspect of the disclosure, the method described herein combines effective pre-existing methods for blocking flash-photography with advances in lighting technology and wearable computing to create a system capable of protecting one's identity in public. The current advancements in LEDs and batteries are capitalized on to create the system. This method makes it possible to emit an always-ready, high intensity light source to disrupt photography and video recording from a plurality of recording devices in a safe, and fashionable manner.

In another prior approach to protecting one's identity, U.S. Pat. App. Pub. No. US2010/0149782 discloses a method and apparatus for inhibiting unwanted photography and video recording. According to the disclosure, this system uses a manually triggered light apparatus to preempt the offending photographer, and in doing so inhibit and deter further attempts. The apparatus disclosed is a hand-operable shaft that allows multiple deterrents to be emitted there from. It is coupled to a rotational member that allows light to pass through a transparent material. The apparatus can be manually triggered by the entity using it, or utilized automatically, according to a predetermined schedule or electronic network, to preempt attempts to take video recording or photographs. The aforementioned system raises several concerns.

First, the system does not sense or detect any lighting events, such as camera flashes. This leaves the user responsible for detecting camera flashes and, in turn, vulnerable to flash photographs they were not able to preempt or detect quickly enough. It also requires the user to preemptively pull the trigger against the assumed offender, which may be problematic in some environments.

Additionally, the lack of sensors requires the user to select the most appropriate counter-light event. This is problematic because a user may become preoccupied or distracted while changing modes in order to provide the most appropriate counter-lighting event. Thus, there exists a need for a system that uses sensory input to increase the usability of the device.

Further, a user may not wish to carry an extra device; may not wish to appear as though they holding, gesturing, or brandishing a device that is held in a similar fashion to a weapon; and may not wish to be seen with a shaft-like device. Thus, there exists a need for a system that addresses the wearability and appearance issues of an identity protection system.

The main goal in the design of the anti-paparazzi system disclosed herein is to enable the wearer to communicate the desire for privacy and to protect it. In one aspect of the disclosure, the anti-paparazzi system makes this notion practical, possible, safe, versatile, and pleasing to the eye. Additionally, the capabilities of sensors and novel algorithms are capitalized upon to improve the usability, wearability, and appearance of the device by automatically classifying lighting events and providing the most appropriate, functional, and efficient response.

In another approach to innovating privacy protecting measures against photography, U.S. Pat. App. Pub. No. US 2006/0159440 discloses a method and apparatus for disrupting an auto focusing mechanism. According to the disclosure, the system detects emission in the ultrasonic, IR and visible light spectrum and returns a signal that distorts the active auto-focus systems.

However, very few modern cameras use ultrasonic range finding for auto-focus mechanism, and increasingly fewer are using active focus altogether. This is because the microprocessors employed in digital cameras are well suited for passive (contrast differencing) auto-focus instead of active auto-focus. Therefore, a need exists for an improved device that can detect auto-focus signals and respond with a signal that obscures the more common passive auto-focus system.

In one aspect of the disclosure, the method described herein uses sensors to detect illumination indicative of an active auto-focus system in the IR, near IR, and visible light spectrums. This signal is used to trigger a light in the visible spectrum that disrupts a contrast differencing, passive auto-focus system.

In another prior approach to obscuring photographs, U.S. Patent App. Pub. No. US2009/0080181 discloses an anti-picture device with a circuit board for detecting a camera's radio frequency, a way of decoding said radio frequency, a switch/driver to trigger device, and a way of producing light with one or more lighting elements.

However, professional cameras are typically equipped with non-wireless flash systems, which do not communicate using radio frequencies. Most paparazzi, as well as event photographers nowadays, use on-camera, shoe-mounted flash, or a similar flash unit tethered to the camera. Radio frequencies cannot reliable be used to detect when a flash photograph is taken and prevent against flash photography. Thus, there exists a need to detect flash photography using other emissions.

Integral to the design of the system described herein is a custom “slave flash” designed to automatically detect and classify lighting events in dynamic light conditions. It uses novel algorithms to analyze signals from multiple photocells 204, phototransistors 206, photovoltaic cells 208, wavelength sensors 210, and color temperature sensors 212 to detect and classify the incoming light event, including its directionality, duration, brightness, speed of increase, color temperature, and relative brightness. Respectively, these sensors are able to detect ambient light, the speed of increase of light, the amount of energy in the light, the wavelength, and the distribution of energy among different wavelengths of the light in order to detect and classify a plurality of lighting events. Using this sensor data, the system is able to generate and emit the most appropriate counter-light event, which will vary in brightness, directionality, wavelength, color, frequency, and duration.

With the advent of video cameras that can record continuous streams of hi-res images and emerging dark-flash photography techniques that operate in the IR and UV spectrum, the stakes are higher. Thus, in another aspect of the disclosure, the new wave of high-brightness (HB) LEDs and high-discharge batteries have opened the doors to create a device that produces the lumens, wavelengths, power, and sensing capabilities needed to protect against modern photographic and video recording methods while still maintaining a portable, safe, and attractive design.

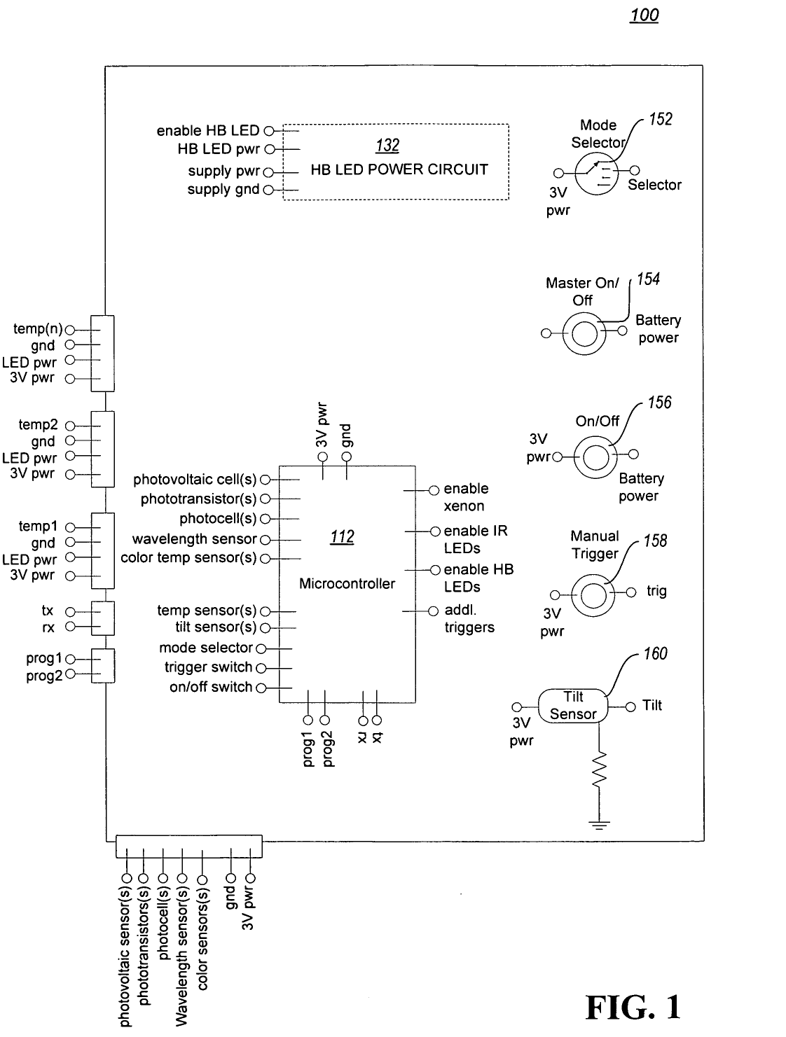

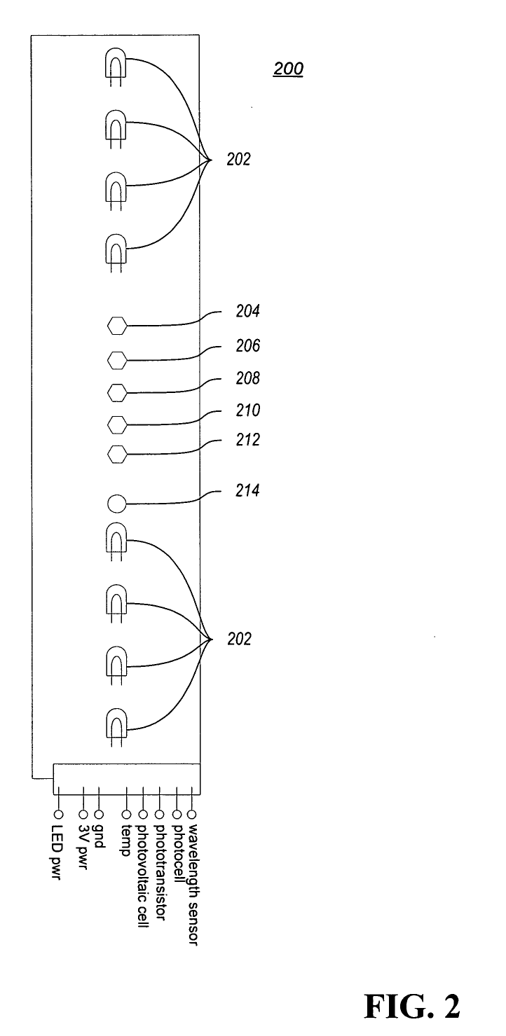

In one aspect of the disclosure, as seen in FIGS. 1 and 2, a custom slave/flash circuit 200 is married with a control circuit 100 having a microcontroller 112, a photocell 204, a phototransistor 206, a photovoltaic cell 208, a wavelength sensor 210, a color temperature sensor 212 and an array of LEDs 202 are used. Tilt sensors 160 were added to allow the wearer to designate the on/off position of the bag and a push-button switch 158 to manually operate the system in case of video recordings or long-duration cell phone flashes. An On/Off switch 156 is also included as a switch to turn on/off the system. And master On/Off switch 154 is used to terminate all power to the system. A power circuit 132 is used to provide power to the LEDs 202. A switch 152 is used to select between the various modes of operation.

A tx/rx pins on the microcontroller 112 allows communication to the system. The system allows an upgrade to the system using prog1/prog2 pins on the microcontroller 112. The slave input on the circuit 100 receives the input signals from the photocell(s) 204, phototransistor(s) 206, photovoltaic cell(s) 208, and wavelength sensor(s) 210, and color temperature sensor(s) 212 while a temperature sensor 214 on the circuit 200 feeds the temp1 input of the microcontroller 112. A second slave/flash circuit such as that shown in FIG. 2 may be used externally or wirelessly to add to the capabilities of the slave/flash circuit 200.

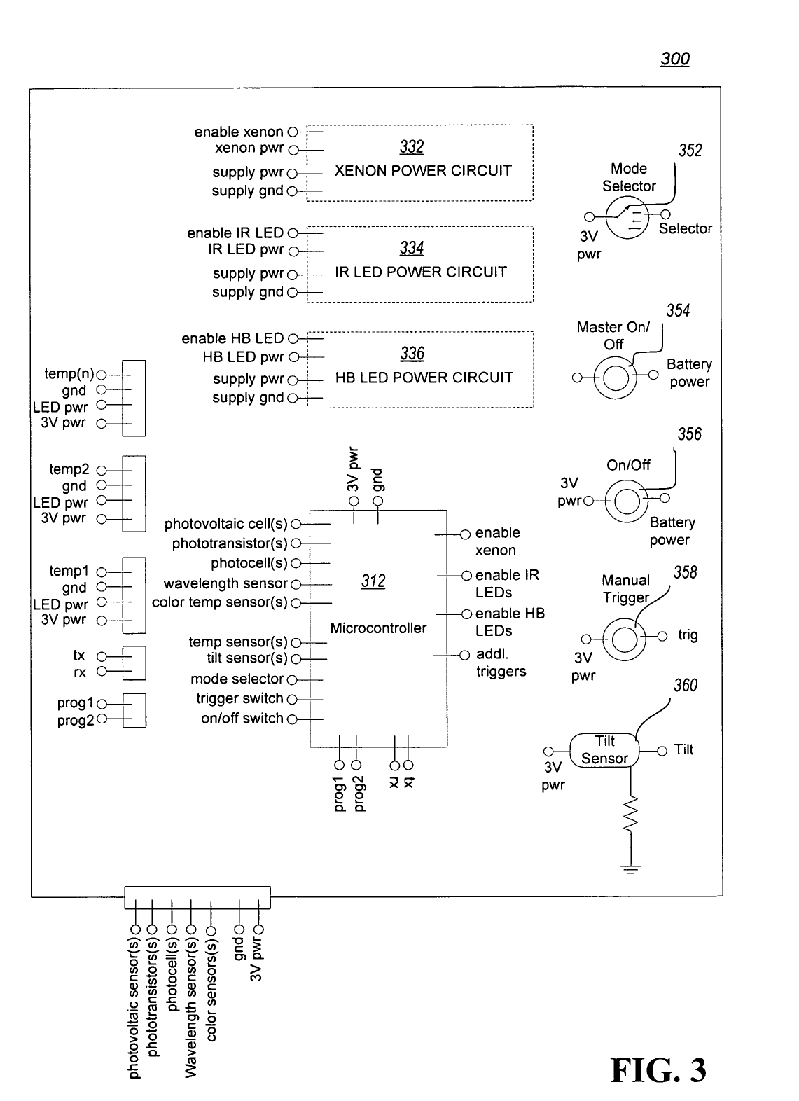

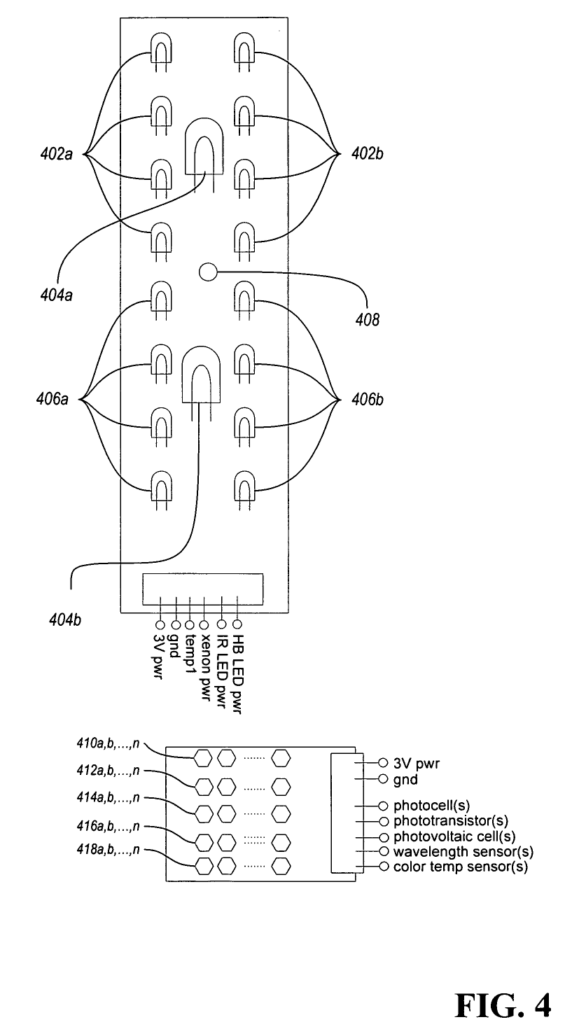

Referring to FIG. 3, an alternate system 300 is disclosed, with specific driver circuits for xenon lights 332, IR LEDs 334 and HB LEDs 336. An On/Off switch 356, and Manual trigger 358 along with tilt sensors 360 operates in a similar fashion as described for their counter-parts in FIG. 1. FIG. 4 illustrates an example of the slave and flash circuits 400 that is usable with the system of FIG. 3, with a set of HB LEDs 402a/b, a set of IR LEDs 406a/b, a set of xenon bulbs 404a/b. In this arrangement, the lighting circuitry is separated from the sensor circuitry to illustrate that it can be arranged and used in varying layouts. The separated slave-circuit module includes a photocell(s) 410a/b/n, phototransistor(s) 412a/b/n, photovoltaic cell(s) 414a/b/n, wavelength sensor(s) 416a/b/n, and a color temperature sensor(s) 418a/b/n. The sensors may be also be used together on the same board as in FIG. 2, separate and wired FIG. 4, or wirelessly.

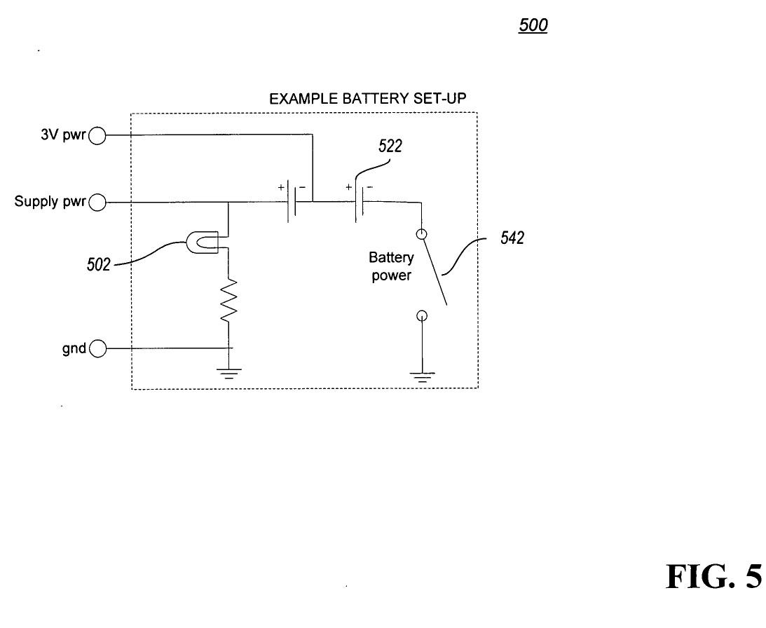

FIG. 5 is an example power circuit 500 that uses a battery 522 with a switch 542 that may power the circuits described herein. Further, the power circuit 500 may include an LED that indicates power is available.

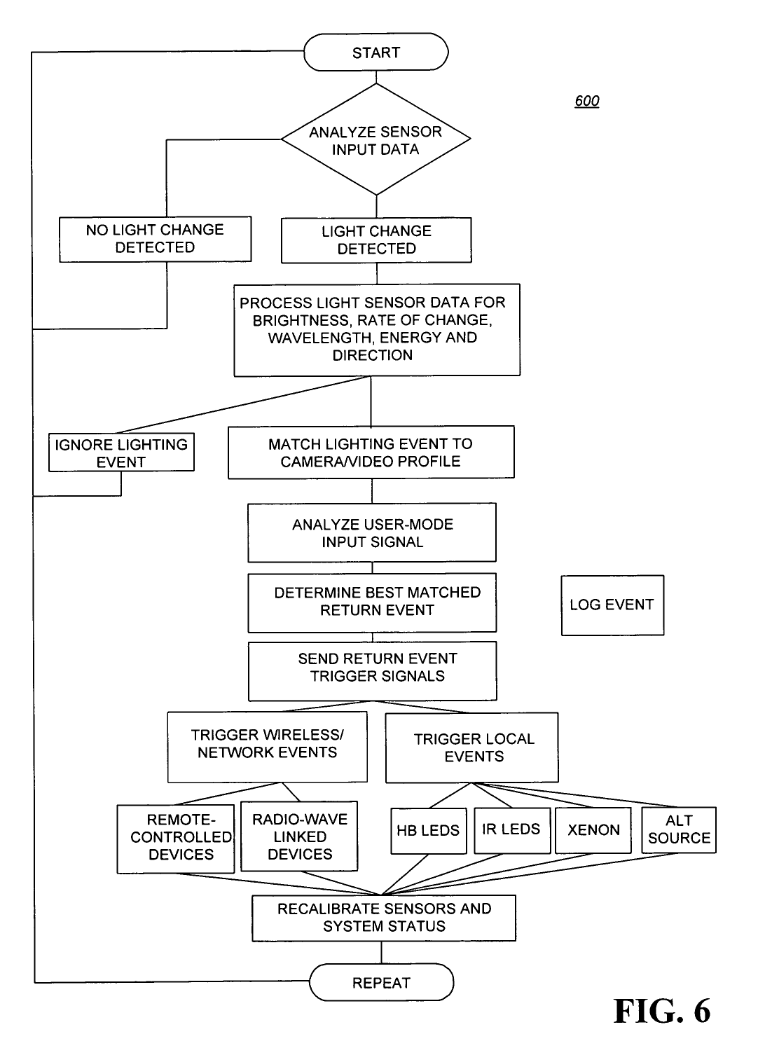

FIG. 6 is a flow diagram with a process 600 that illustrates the operation of the lighting algorithm of the system described herein.

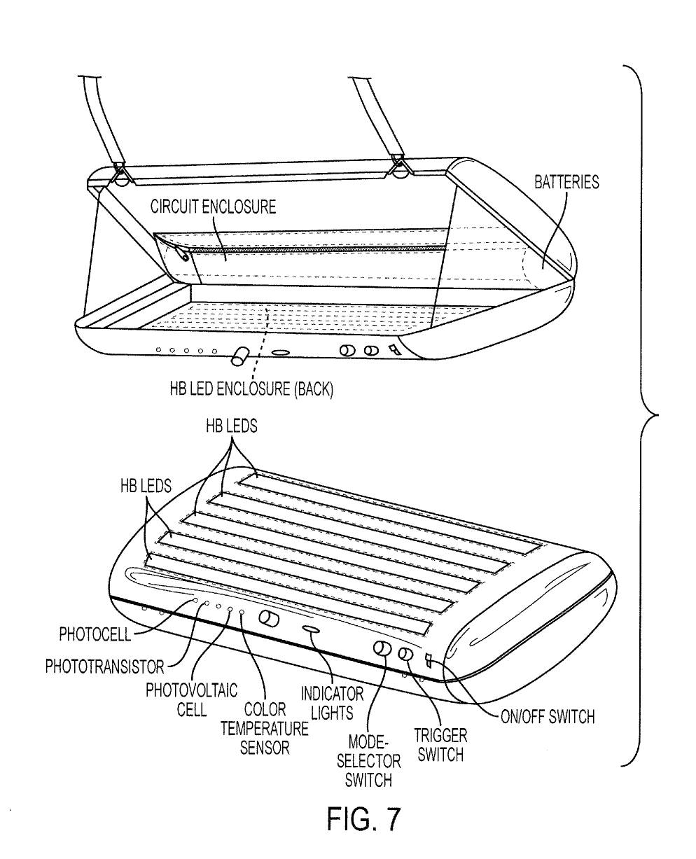

FIG. 7 illustrates a purse that contains the privacy system described herein.

In one aspect of the system, this technology is embedded into a clutch bag. By making the circuit smaller, adding LEDs and optimizing the code to detect flashes in varying light conditions, the system could overexpose flash-photographs shot at 1/125 of a second or slower, at F4 aperture, and ISO 800 film speed. In another aspect of the system, where the device, using an arrangement similar to FIG. 1 and FIG. 2, reacted over two times as fast and over eight times brighter than the original prototype overexposing flash photographs shot at 1/250 of a second or slower, at F7.1 aperture or larger, and ISO 400 or greater on a Nikon D90 digital SLR camera. Further development towards a more robust commercial version can offer increased gains in speed and brightness.

The different parts of the circuit and be modularized for different designs. For example a 3-piece fashion accessory could be worn that includes: (1) a sensor such as a pendant; (2) a light and power source such as a bag; and (3) a wireless microcontroller, even an iPhone could be used via Bluetooth to process the signals from (1) the pendant, run the algorithms and send the trigger events to (2) light source.

The goal of the anti-paparazzi system is not to create a weapon against photography, but a compliment to it. Certainly, blocking all access to one's image might be overzealous or, in some cases, self-destructive. However the disclosed system gives its user the power to choose when to be photographed. The concept has been effectively incorporated in a clutch/purse and a suite of other accessories for men and women may be created based on this technology, including briefcases, other bags, brass knuckles, pendants and tie tacks. Other designs may include a wearable apparatus for military or law enforcement uses.

As a response to the rise of paparazzi, the expanse of digital cameras and the resulting erosion of privacy, the anti-paparazzi system described herein offers the power to control ones identity in public and protect against a wide range of optical recording devices in dynamic lighting conditions. In one aspect of the disclosure, the system includes devices that are wearable, effective, versatile, and fashionable--providing an on-demand, always-ready source of identity protection.

Some key concepts of the system described herein are:

### Hardware

use of variety of light sources (led varieties (size, ir, visible), xenon)

use of high brightness (HB) LEDs

use of one or more batteries

use of a small micro-controller/wearable computer

use of new state-of-the-art high discharge lithium ion batteries

small package, which required novel design

creative heatsinking (draw a few examples of possible shells, including rib-cage, conductive fabric, bottom & edging)

a secondary, easy to access, on/off switch to toggle on/off state of system

additional user-controlled device light-trigger

power supplies and control circuitry can be placed on separate board from light sources and sensing circuitry

modular electronic design allows for a flexible design and configuration or light-source(s) and sensor(s)

optics to focus, spread, or diffuse emitted light

optics to condense or diffuse light onto sensors

an additional tilt switch in the current embodiment

tilt sensor(s) to detect up to 6-axis of positioning and set active and inactive modes

accelerometer in place of or in combination with tilt switches to detect position and/or gesture

a master on/off safety switch to disconnect all power

a switch to select between different user modes

sensor(s) to detect wavelength of light

sensor(s) to detect color of light

sensor(s) to detect speed of increase of visible, IR, and/or UV light

sensor(s) to detect visible, IR, and/or UV ambient light

sensor to detect visible, IR, and/or UV light energy

### Electronics

innovates the use of high discharge battery sources for rapid response

thermal sensing improves efficiency by shutting down over-driven circuit

thermal sensing feedback to circuit and/or microcontroller improves safety by limiting power when bag temperature is too high

auto shut-off if left on for too long

indicator(s) for low battery level, system status and on/off state

indicator(s) for currently selected mode

using new high brightness LEDs requires less power

using new high brightness LEDs allows for the first flashback identity protection device with a sustained flash

using new high brightness LEDs allows for longer lifespan of lighting elements

using new high brightness LEDs allows for lighting element without glass enclosure

using new high brightness LEDs allows for lighting element without dangerous voltages

trigger can be induced by hardware (electronics), by software on the microcontroller, or by the user

trigger can be induced directly by user in case of demonstration, as a backup, as a deterrent, or as a means of overexposing non-flash photo/video recordings

brightness control can be set by ambient light levels, detected strength of incoming flash, manually, or algorithmically

LEDs/light-sources can be configured in a variety of series or parallel configurations

current controlled brightness

LED power driver can operate under a variety of input supply conditions, corrects for degration of battery voltages over time, allows for use of a variety of battery types and configurations

light-sources can be powered by transistor based DC-DC converters allowing for high efficiency operation

individual light sources can be used simultaneously, individually, or in various configurations and at varying light levels and frequencies to produce alternating patterns of light that disrupt video recordings as well as autofocus and auto-exposure systems

### Algorithms

use of microcontroller allows for updatable algorithmic control of device functionality

algorithmic detection of flash direction from a single or multiple sensors

direct counter-flash in best direction (e.g. powering an angled selection of one or more LEDs/lights, or motorization of components)

tracking of ambient light levels to moderate the light power and wavelength of the device

algorithmic detection, classification, and tracking of levels and changes in ambient brightness

detection and classification of sudden change in light indicative of conventional camera flash

detection, classification, and tracking of flash brightness to moderate return brightness of the device

user-moderated activation levels (user can set into always flashback mode, only active when in tilt mode, flashback using auto-adjusted light levels, flashback using predetermined light levels)

flexible programming available for additional user-requested functionality

detection, classification, and tracking of levels and changes in the intensity of visible, IR, and/or UV light

detection, classification, and tracking of changes in the speed of increase of visible, IR or UV light

detection, classification, and tracking of levels and change in wavelength

detection, classification, and tracking of duration of flash event

algorithm to detect overlapping flashes (flashes that occur during a counter-flash)

algorithm to adjust sensitivity of sensors to flashes in varying conditions (e.g. an environment with colored flashing police/ambulance lights has different sensitivity settings than a pitch dark environment)

algorithm for recognizing and classifying different types of flashes (pre-flash, red-eye reduction flash, mobile-phone/LED flash, IR flash, UV flash) based on input from multiple sensors (photocell(s), phototransistor(s), photovoltaic cell(s), wavelength sensor(s), and color temperature sensor(s))

use of microcontroller allows for additional flash profiles to be added to program

algorithm for adjusting the duration of the counter-flash based on the detected flash event (e.g. detection of a sustained flash, indicative of a mobile phone flash or video recorder light, would generate a sustained counter-light, instead of a brief counter-flash)

algorithm to choose best response to detected flash event (e.g. detection of a sustained flash, indicative of mobile phone flash or video recorder, can return a pulse-width modulated counter-light specifically tuned to distort video recording devices and specific shutter recording algorithms. For example, the iPhone currently records an image by scanning from left to right and top to bottom)

algorithm to adjust the type of the counter-flash (IR, visible, LED, xenon) based on the detected flash event

algorithm to prevent false-triggering from non-photographic flash events based on combination of input from plurality of sensors (photocell(s), phototransistor(s), photovoltaic cell(s), wavelength sensor(s), color temperature sensor(s))

### Methods of Interaction

unique portability of device due to electronic design choices

portability makes device friendly and usable

portability allows for installation into a variety of packages/accessories

attractive design encourages use of device

user can toggle active/inactive mode of camera/flash sensing

user can toggle easy access device power button

user can use button to manually trigger device response

novel tilt-mode activation is easy to use and fast to respond to user intent

user can choose from several modes of operation, using the selector switch, that vary the responses and functions of the system. In one embodiment, mode 1 sets the system to generate a counter-light only when in a vertical position, while mode 2 sets the system to generate a counter-light only when it is in a horizontal position, and mode 3 sets the system to generate counter-light events in all positions. Additional modes could provide the user with the option to vary the strength of the counter-lighting event, activate data-logging, put the system to sleep, and/or deactivate any indicator lights.

### Applications, Capabilities and Methods For Identity Protection

privacy protection

to help celebrities (as well as non-celebrities) control their image with the paparazzi

to enable the user to control their image in public/private

innovates identity protection device to “wearables” field (as recognized by ISWC International Symposium on Wearable Computers)

innovates identity protection device to everyday devices

novel to use fashionability as a design principle

fashionability opens device to new audience of users

creations can be marketed as a stand alone products or the technology can be installed into pre-existing goods

capable of returning pulse(s) of light sufficient to overexpose and degrade the quality of a photograph;

capable of flashing back in the direction of the camera creates specular reflections through the lens of an optical recording device;

capable of returning rapid pulse(s) of light sufficient to overexpose video recordings and degrade quality of recording;

capable of returning high-frequency pulse(s) of light capable of obscuring auto-focus algorithms that employ contrast differencing to determine focal plane;

capable of returning high-frequency pulse(s) of light capable of causing errors auto-exposure algorithms;

capable of returning pulse(s) of light that outside of the visible light spectrum to overexpose optical recording devices operating in that spectrum (IR, UV);

capable of being removed from fashion accessory to be recharged or not worn;

capable of being used as a continuous light source;

capable of being used as an emergency source of light;

capable of being used as a flashlight;

capable of emitting light in various colors using colored lights and/or colored optics or filters;

capable of being paired with optical filters or overlays on the lens for varying light patterns, designs, text (such as in the Image Fulgarator1);

capable of being used against a wide array of modern day optical recording devices including but not limited to digital point and shoot camera, digital single lens reflex cameras (dSLR), film point and shoot camera, film single lens reflex (SLR), 35 mm, medium format, large format, cellphone/smartphone, hi-def video, surveillance cameras;

capable of a design to target optical recording devices in a close proximity (<10 ft), medium distance (10-20 ft) or long range (20 ft+);

capable of a design to emit light in patterns ranging from full 360° spread of light to a narrow ≈3° beam of light (depending on optical design choices); or

capable of a design to emit light in the direction of the wearer in order to overexpose their image as opposed to in the direction of the photographer, which directly overexpose that area of the image. Though the main function consists of using a flashback of light in the visible spectrum the device is also capable of being coupled with alternate or additional means of identity protection such as firing marking dyes (that appear in the visible or UV spectrum), self-defensive sprays (including tear gas or pepper gas), air-powered projectiles, spring-powered projectiles, alarm sounds, radio waves, and even other lighting systems:

capable of using microcontroller for additional applications such as recording the number of flashbacks that occur (data collection)

transmitting this data to another device such as a computer (data transmission)

being used in conjunction with flash photography as a slave flash (for intentionally photographing someone and not blocking their identity)

capable of existing as a device can be worn in multiple parts and connected via wireless signals in various wireless network topologies including star, tree, bus, ring or mesh; or

capable of a design that can be wirelessly synchronized with other like devices (wireless slave-flashes).

Various aspects described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media may include, but are not limited to, magnetic storage devices, optical disks, digital versatile disk, smart cards, and flash memory devices.

The disclosure is not intended to be limited to the preferred aspects. Furthermore, those skilled in the art should recognize that the method and apparatus aspects described herein may be implemented in a variety of ways, including implementations in hardware, software, firmware, or various combinations thereof. Examples of such hardware may include ASICs, Field Programmable Gate Arrays, general-purpose processors, DSPs, and/or other circuitry. Software and/or firmware implementations of the disclosure may be implemented via any combination of programming languages, including Java, C, C++, Matlab™, Verilog, VHDL, and/or processor specific machine and assembly languages.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The method and system aspects described herein merely illustrate particular aspects of the disclosure. It should be appreciated that those skilled in the art will be able to devise various arrangements, which, although not explicitly described or shown herein, embody the principles of the disclosure and are included within its scope. Furthermore, all examples and conditional language recited herein are intended to be only for pedagogical purposes to aid the reader in understanding the principles of the disclosure. This disclosure and its associated references are to be construed as being without limitation to such specifically recited examples and conditions. Moreover, all statements herein reciting principles, aspects, and aspects of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying principles of the disclosure. Similarly, it should be appreciated that any flow charts, flow diagrams, signal diagrams, system diagrams, codes, and the like represent various processes that may be substantially represented in computer-readable medium and so executed by a computer or processor, whether or not such computer or processor is explicitly shown.

It is understood that any specific order or hierarchy of steps described in the context of a software module is being presented to provide an examples of a wireless node. Based upon design preferences, it is understood that the specific order or hierarchy of steps may be rearranged while remaining within the scope of the disclosure.

Although various aspects of the disclosure have been described as software implementations, those skilled in the art will readily appreciate that the various software modules presented throughout this disclosure may be implemented in hardware, or any combination of software and hardware. Whether these aspects are implemented in hardware or software depends upon the particular application and design constraints imposed on the overall system. Skilled artisans may implement the described functionality in varying ways for each particular application, but such implementation decisions should not be interpreted as causing a departure from the scope of the disclosure.

What is claimed is:

1. A method comprising:
detecting a lighting event for capturing a photo; and
responding with a light that disrupts the capturing of the photo.
